(19) United States
(12) Patent Application Publication
(10) Pub. No.: US 2003/0069690 A1
(43) Pub. Date: Apr. 10, 2003

(54) Method and system for navigation-enhanced directory assistance

(75) Inventors: John J. Correia, Livonia, MI (US); Jefferey M. Stefan, Clawson, MI (US); Larry J. Tretyak, Highland, MI (US)

Correspondence Address: General Motors Corporation, Legal Staff Mail Code 482-C23-B21, 300 Renaissance Center, P.O. Box 300, Detroit, MI, 48265-3000, US

(73) Assignee: General Motors Corporation

(21) Appl. No.: 09/970,575

(22) Filed: Oct. 4, 2001

(51) Int. Cl. G01C 21/34

(52) U.S. Cl. 701/211; 701/209; 340/995

(57) ABSTRACT

The invention provides a method of providing navigation-enhanced directory assistance instructions to a mobile vehicle. A point of interest is selected from within a proximity region of a mobile vehicle location, based on a point of interest request. A plurality of routing instructions is determined based on the selected point of interest. At least one of the routing instructions is provided to the mobile vehicle in response to a routing option input.

### FIELD OF THE INVENTION

This invention relates to a method for providing navigation instructions to a mobile vehicle. More generally, the invention relates to a method and system for navigation-enhanced directory assistance.

### BACKGROUND OF THE INVENTION

Requests for directory assistance requests from a driver or occupant of a mobile vehicle have not included the current position of the mobile vehicle when searching and selecting candidate points of interest for phone numbers or address information. Furthermore, directory assistance responses have not provided directions or routing instructions to assist the driver in navigating to the point of interest, although responses may provide additional services of connecting a call to the business, home or point of interest.

In general, directory assistance requests may be made by calling a directory assistance operator, by thumbing through the white or yellow pages of a telephone directory, by consulting a database residing on a CD ROM or other computer media, or by an on-line inquiry using the Internet. Instructions to drive to a selected point of interest may be delivered to the vehicle operator in several ways including: verbal instructions from a knowledgeable occupant; adamant finger-pointing by an occupant during route transitions; prior written directions between the source and destination points; driver's knowledge of the local geographical area; on-board maps; in-vehicle electronic street maps; or an on-board global positioning system (GPS) used in conjunction with an address of a destination point and a local database of streets and geographical terrain.

However, these approaches do not provide directory assistance, an address of a selected destination, or routing instructions to the selected destination that are based on the current geophysical location of the mobile vehicle.

It would be desirable, therefore, to provide a method for enabling and enhancing directory assistance based on the current position and intended route of the mobile vehicle, and to provide routing instructions for reaching the destination.

### SUMMARY OF THE INVENTION

One aspect of the invention provides a method of providing navigation instructions to a mobile vehicle. A point of interest may be selected from a region in proximity to the location of the mobile vehicle. A plurality of routing instructions may be determined based on the selected point of interest. At least one of the routing instructions to the mobile vehicle may be provided in response to a routing option input.

The point of interest request may be based on one or more items including distance between the point of interest and the mobile vehicle, category of the point of interest, and sub-category or genre of the point of interest. Voice communications may be used, in part, for selecting the point of interest. Possible points of interest may be determined by surrounding the vehicle location with a polygon. The point of interest may be within the region defined by the polygon.

Selected points of interest may be provided, for example, to an on-board autonomous navigation system.

The routing instructions from the vehicle location to the point of interest may be provided in a predetermined sequence. The routing instructions may be provided to the vehicle user. Various methods may be used to provide the routing instructions to the vehicle user, including major exit routing instructions, major cross street routing instructions, major intersection routing instructions, last-mile routing instructions, turn-by-turn routing instructions, last-turn routing instructions, voice routing instructions, and voice memo routing instructions. The vehicle user may receive routing instructions, for example, via a graphical interface or a voice user interface. The vehicle user may receive routing instructions together or may receive them one at a time, based on the location of the vehicle with respect to a maneuver. The routing option input may include a mobile vehicle user selection, and the selected routing option input may be predetermined. The routing instructions may be provided to the vehicle using at least a portion of a wireless communication system.

Another aspect of the current invention is a computer usable medium, including a program for providing navigation instructions to a mobile vehicle.

The program may include computer program code for selecting a point of interest in proximity to the vehicle location based on a point of interest request. The program may include computer program code for determining a plurality of routing instructions based on the selected point of interest, and may also contain computer program code for providing at least one of the routing instructions to the mobile vehicle in response to a routing option input. The computer program code may further provide routing instructions to a mobile vehicle user. The computer program code may further provide the selected point of interest to an autonomous navigation system. The computer program code may further transmit the routing instructions to the vehicle using at least a portion of a wireless communication system.

Another aspect of the current invention is a directory assistance system for providing navigation instructions to a mobile vehicle.

The navigation-enhanced directory assistance system may provide a means for selecting a point of interest in proximity to the mobile based on a point of interest request. The navigation-enhanced directory assistance system may provide a means for determining a plurality of routing instructions based on the selected point of interest, and a means for providing at least one of the routing instructions to the mobile vehicle in response to a routing option input.

The system may also provide a means for transmitting the routing instructions to the mobile vehicle using at least a portion of a wireless communication system.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment of a directory assistance system for providing navigation-enhanced directory assistance in accordance with the current invention;

FIG. 2 is a flow diagram of one embodiment of a method for navigation-enhanced directory assistance in accordance with the current invention;

FIG. 3 is a flow diagram of one embodiment of a method for enhanced directory assistance in accordance with the current invention;

FIG. 4 is a flow diagram of one embodiment of a method for enhanced navigation services in accordance with the current invention;

FIG. 5 is a flow diagram of another embodiment of a method for enhanced directory assistance in accordance with the current invention; and

FIG. 6 is a flow diagram of another embodiment of a method for enhanced navigation services in accordance with the current invention.

### DETAILED DESCRIPTION OF THE PRESENTLY PREFERRED EMBODIMENTS

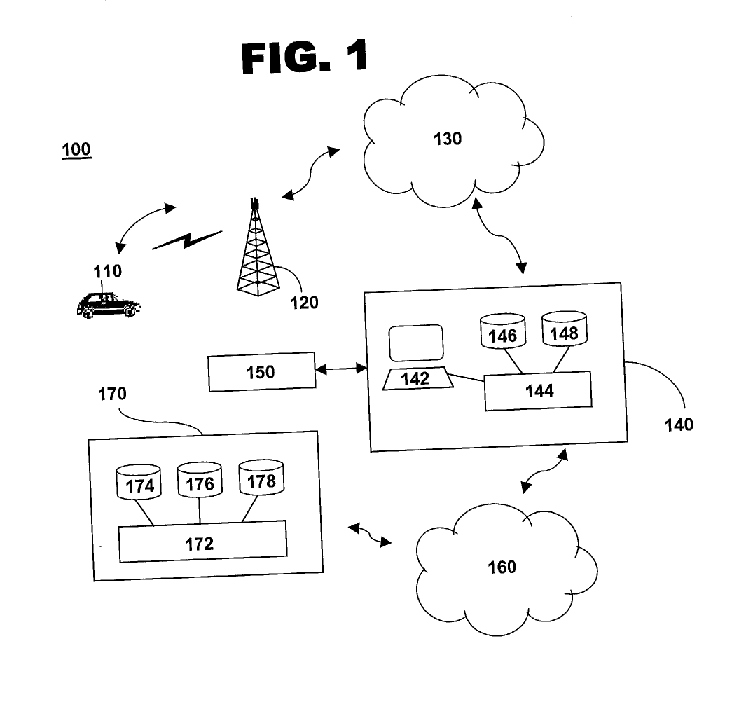

FIG. 1 shows one embodiment of a directory assistance system for providing navigation instructions to a mobile vehicle in accordance with the present invention at 100. The navigation-enhanced directory assistance system 100 may include one or more mobile vehicle clients 110; one or more carrier systems 120; one or more communication networks 130, 160; one or more directory assistance service managers 140; one or more navigation instruction applications 150; and one or more database application managers 170.

Mobile vehicle client 110 may be, for example, any mobile vehicle suitably equipped to convey point of interest requests from mobile vehicle client 110 for navigation-enhanced directory assistance services and to receive navigation-enhanced directory assistance. Mobile vehicle client 110 may also be, for example, a driver or an occupant of a mobile vehicle carrying suitable hardware to convey requests from mobile vehicle client 110 for navigation-enhanced directory assistance services and to receive navigation-enhanced directory assistance.

Carrier system 120 may be any suitable system for transmitting wireless signals from mobile vehicle client 110 to communication network 130. Carrier system 120 may be, for example, a mobile phone system. Carrier system 120 may receive radio signals from mobile vehicle client 110, and may transmit radio signals to mobile vehicle client 110. Carrier system 120 may be a cellular phone system operating nominally at 800 MHz. Carrier system 120 may also be a cellular phone system operating nominally at 900 MHz, or at 1900 MHz. Carrier system 120 may also be, for example, a transmitter/receiver unit attached to vehicle client 110. Alternatively, carrier system 120 may include a separate transmitter/receiver carried by vehicle client 110. Carrier system 120 communicates with communication network 130.

Communication network 130 may be any suitable network for transmitting and receiving communications from carrier 120. Communication network 130 may be, for example, another wireless network, a mobile telephone switching office, a public switched telephone network, a private broadcast network, a fiber network, a wired network, or any combination thereof. Communication network 130 may be connected to directory assistance service manager 140. Communication network 130, in conjunction with carrier 120, may connect mobile vehicle client 110 to directory assistance service manager 140. Connection of mobile vehicle client 110 to directory assistance service manager 140 may allow communications to be transmitted between mobile vehicle client 110 and directory assistance service manager 140. Services may be received by mobile vehicle client 110 from directory assistance service manager 140.

Directory assistance service manager 140 may include directory assistance application 142. Directory assistance service manager 140 may further include database information application 144 and databases 146, 148. Directory assistance service manager 140 may provide directory assistance services to mobile vehicle client 110. Directory assistance application 142 may receive requests for directory assistance services from mobile vehicle client 110. Directory assistance application 142 may generate directory assistance information for mobile vehicle client 110. Directory assistance application 142 may also generate navigation information for mobile vehicle client 110.

Directory assistance application 142 may require information from database 146, 148. Database information application 144 may assist directory assistance application 142 for accessing information contained in database 146, 148. Database information contained in database 146, 148 may include, for example, address information for points of interest such as businesses, residences or attractions. Database 146, 148 may also include for example, supplemental information regarding points of interest. Database 146, 148 may include, for example, roadway information related to points of interest. Database 146, 148 may also include, for example, geographical information about businesses, residences or points of interest.

Directory assistance service manager 140 may be connected to database application manager 170. Directory assistance service manager 140 may be connected to database application manager 170 through communication network 160. Communication network 160 may be, for example, one or more wireless, fiber, or wired networks.

Database application manager 170 may include database information application 172, and one or more databases 174, 176, 178. Database 174, 176, 178 may include, for example, dynamic information regarding road conditions, traffic flow, local weather, accidents or transit times. Dynamic information may include up-to-the-minute information regarding a business, home, point of interest, or road conditions.

Directory assistance service manager 140 may be connected to navigation instruction application 150. Navigation instruction application 150 may provide navigation and routing instructions to directory assistance service manager 140 upon a point of interest request from mobile vehicle client 110.

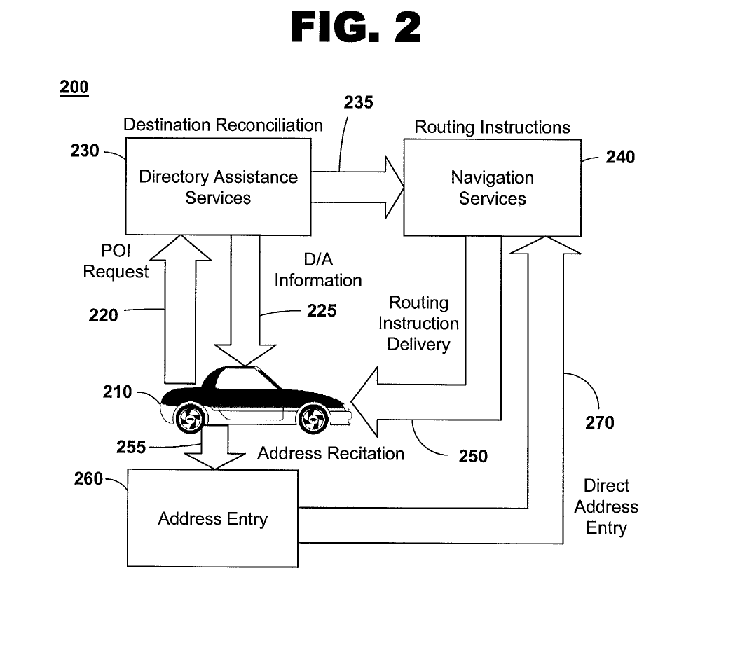

FIG. 2 shows a flow diagram of one embodiment of a method for navigation-enhanced directory assistance in accordance with the present invention at 200.

Navigation-enhanced directory assistance method 200 may include one or mobile vehicle clients 210, one or more directory assistance service managers 230, and one or more navigation service managers 240.

Mobile vehicle client 210 may be, for example, any mobile vehicle suitably equipped to submit and receive point of interest requests for navigation-enhanced directory assistance services. Mobile vehicle client 210 may also be, for example, a driver or an occupant of a mobile vehicle carrying suitable hardware to submit and receive point of interest requests for navigation-enhanced directory assistance services. Mobile vehicle client 210 may submit a user request 220 to request business, residence or point of interest information from directory assistance service manager 230. Mobile vehicle client 210 may receive directory assistance information 225 from directory assistance service manager 230.

Directory assistance service manager 230 may be any suitable hardware and software capable of supplying directory assistance services to mobile vehicle client 210. Directory assistance service manager 230 may receive a point of interest request from mobile vehicle client 210. Directory assistance service manager 230 may provide directory assistance information 225 to mobile vehicle client 210. Directory assistance information 225 may include, for example, a desired phone number, a call connection, or a recitation of an address of a business, residence or point of interest.

Directory assistance manager 230 may provide points of interest in proximity to the mobile vehicle in response to a point of interest request. Mobile client 210 may select one of the points of interest. Directory assistance service manager 230 may include a directory assistance application and associated databases. Directory assistance service manager 230 may be capable of requesting and receiving database information from external databases. The external databases may contain, for example, updated or dynamic information about traffic incidents, road conditions, traffic flow, weather, accidents or transit times. Dynamic information may include up-to-the-minute information regarding a business, home, point of interest, or road conditions. Directory assistance service manager 230 may submit directory assistance service information 235 to navigation service manager 240. Directory assistance service information 235 may include, for example, a destination address.

Navigation service manager 240 may be any suitable hardware and software capable of providing navigation services to mobile vehicle client 210. Navigation service manager 240 may receive directory assistance information from directory assistance service manager 230. Navigation service manager 240 may determine one or more routing instructions 250 to mobile vehicle client 210 based on the selected point of interest. Routing instructions 250 may be provided to mobile client 210. Routing instructions 250 may be provided based on a routing option input. The routing option input may determine, for example, how routing instructions are provided to mobile vehicle client 210. Navigation service manager 240 may receive a destination address 270 directly from address entry service 260. Address entry service 260 may be, for example, a service provided by directory assistance manager 230. Address entry service 260 may be, for example, an application providing address recitations 255 to navigation service manager 240. Address entry service 260 may provide location information regarding mobile vehicle client 210 to navigation service manager 240. Address entry service 260 may provide a destination address and current location information of mobile client 210 to navigation service manager 240. Address entry service 260 may receive an address recitation 255 from mobile vehicle client 210. Address recitation 255 may be an address of a destination known by mobile vehicle client 210. Address recitation 255 may include a voice communication from mobile vehicle client 210. Address recitation 255 may include a data transmission from mobile vehicle client 210 to navigation service manager 240.

Mobile vehicle client 210 may submit a point of interest or directory assistance user request 220 to directory assistance manager 230. User request 220 may contain, for example, information regarding the type of directory assistance and navigation assistance services desired. User request 220 may contain, for example, current vehicle location information, heading information and speed information from, for example, an on-board global positioning system (GPS). User request 220 may also contain information about a desired business, residence, or point of interest. User request 220 may further contain information about the point of interest, such as category, sub-category, genre or brand. User request 220 may also contain information, for example, regarding the type of navigation services desired from navigation service manager 240. User request 220 may also contain a routing option input regarding the preferred delivery method of routing instructions 250. The routing option input may be selected by mobile client 210. The routing option input may also be a predetermined selection.

Mobile vehicle client 210 may communicate destination address 270 to navigation service manager 240 for example, if destination address 270 is already known. Mobile client 210 may recite or may transmit the address of the destination to address entry service 260. Address entry service 260 may provide a current location of the mobile vehicle and destination address 270 to navigation service manager 240. Directory assistance services, such as a phone number, address recitation, address transmission, or call connect, may be delivered to mobile vehicle via directory assistance information 225.

Directory assistance manager 230 and address entry service 260 may form a front end of mobile vehicle request servicing. The front end may be, for example, services related to destination reconciliation. Navigation service manager 240 and address entry service 260 may form a back end of mobile vehicle request servicing. The back end may be, for example, services related to routing instructions.

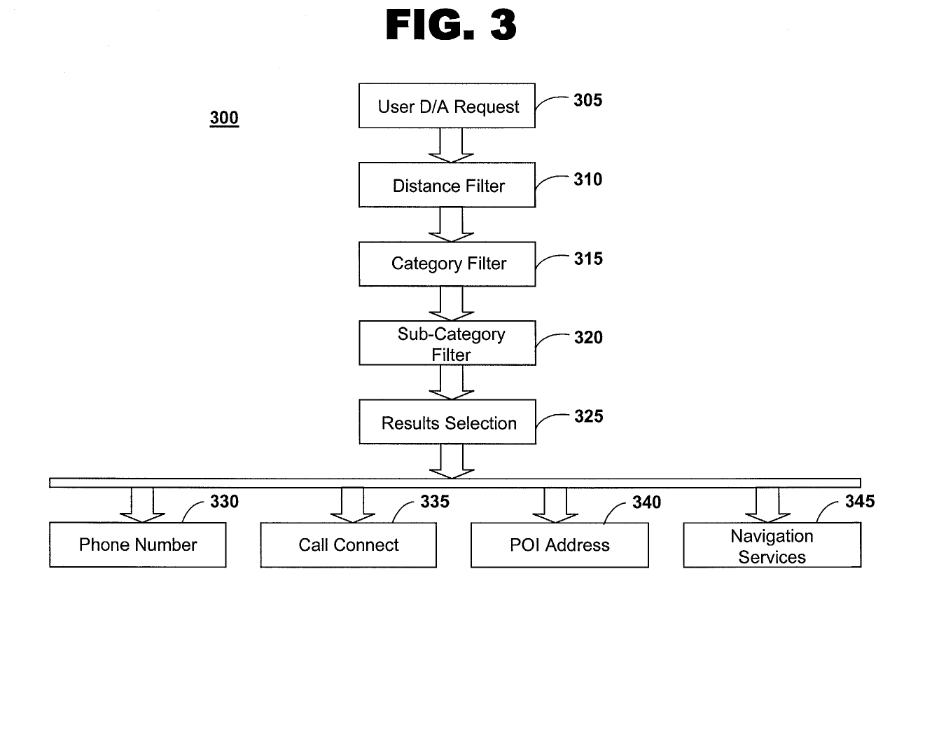

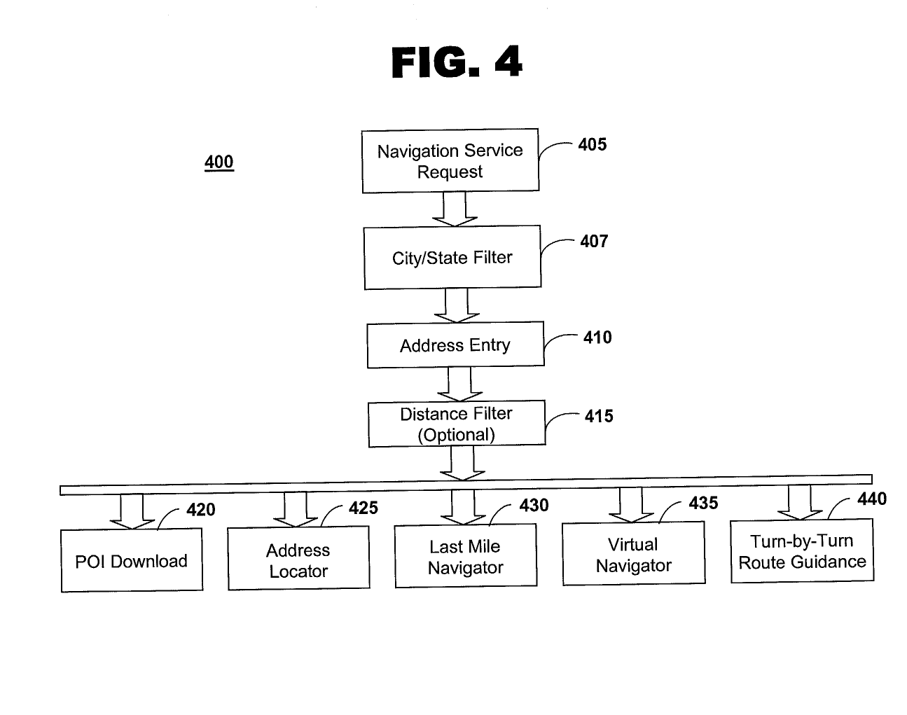

FIG. 3 shows a flow diagram of one embodiment of a method for enhanced directory assistance in accordance with the present invention at 300. FIG. 3, in conjunction with FIG. 4, illustrate a method by which a location of a mobile vehicle may be reconciled with a physical address and coupled to an array of navigation enhanced directory services.

Enhanced directory assistance method 300 may include a series of steps to provide, for example, navigation-enhanced directory assistance information and navigation instructions to mobile vehicle client 210.

As can be seen at block 305, mobile vehicle client 210 may submit a point of interest request for directory assistance. Mobile vehicle client 210 may submit a point of interest request, for example, when the user needs to locate or call a point of interest, or when the user desires navigation services to reach the intended point of interest. A point of interest may be a business, residence, attraction, or any geographically located site.

Selection of a point of interest may be based on distance from the mobile vehicle location to the point of interest. A distance filter may be used to determine suitable points of interest, as seen at block 310. The distance filter uses proximity information to define a proximity region around mobile vehicle client 210. The proximity region may be represented, for example, by a polygon around the mobile vehicle location. Mobile vehicle client 210 may provide proximity information, or the proximity information may be, for example, default proximity information. The proximity region may be represented, for example, by a polygon containing multiple facets to approximately form a circle with radius n miles around the current mobile vehicle location. The proximity region may be represented, for example, by a polygon in the shape of a square centered on the current mobile vehicle location, where the distance from the current mobile vehicle location to the center of each side is, for example, n miles. The number n may be, for example, equal to two. The proximity region may be represented, for example, by a polygon in the shape of a corridor, n miles wide on either side of an intended vehicle path. The proximity region may be represented, for example, by a cone-shaped polygon extending around the current mobile vehicle location with the cone pointed in the current direction of travel of the mobile vehicle. The proximity region may be based on, for example, the current direction of the mobile vehicle or on the intended route of the mobile vehicle. One or more points of interest may be selected from a database based on whether the business or points of interest lie within the proximity region. If no points of interest lie within the proximity region, the polygon representing the proximity region may be enlarged. If a large number of points of interest lie within the proximity region, the polygon may be made smaller or another filter may be used.

Selection of a point of interest may be based on a category of the possible points of interest, as seen at block 315. A category filter may be applied to further narrow the directory assistance request for determining potential points of interest within proximity to mobile vehicle client 210. The category filter may be, for example, a filter for selecting a type of point of interest, such as a restaurant, convenience store, or bookstore. The category filter may be, for example, part of a constraint clause or part of a query statement for a database search. The category filter results in narrowing the possible points of interest in response to the directory assistance request.

Selection of a point of interest may be based on a genre or sub-category of the possible points of interest. A sub-category filter may be applied to further narrow the directory assistance request for determining potential points of interest within proximity to mobile vehicle client 210, as seen at block 320. The sub-category filter may be, for example, a filter for selecting a specific type of business or point of interest, such as a particular restaurant chain, type of food, gas station franchise, convenience store, bookstore or brand. The sub-category filter may be, for example, part of a constraint clause or part of a query statement for a database search. The sub-category filter results in further narrowing the possible points of interest in response to the directory assistance request.

As seen at block 325, the results after distance, sub-category and category filters may be provided in response to the directory assistance request. If the results are satisfactory, one of a number of further actions may be performed. If the results are not satisfactory, a repeat of the search may be made, for example, with a larger or smaller proximity region, different category, or broader or narrower sub-category filter. Point of interest selection may include, for example, at least one voice communication. Results of the directory assistance request may be delivered to mobile vehicle client 210, for example, with a voice user interface. Results of the directory assistance request may be delivered with a graphical user interface. A graphical user interface may be, for example, a heads-up display. The selection of results or point of interest from the directory assistance request may be given with a voice user interface, graphical user interface, or any suitable computer input device.

As seen at blocks 330, 335, 340 and 345, one of several actions may be taken in response to the results selection. The action to be taken may be selected by mobile vehicle client 210. The action taken may also be predetermined. For example, a predetermined response may be a default response. A predetermined response may also be based on a user profile. A predetermined response may also be based on the results selection.

A phone number for the selected point of interest may be provided to mobile vehicle client 210, as seen at block 330. The phone number may be recited verbally to mobile vehicle client 210. Mobile vehicle client 210 may be connected to the phone number of the selected point of interest, as indicated at block 335. The street address, geographical location or URL of the point of interest may be delivered to mobile vehicle client 210, as indicated at block 340. The address may be recited verbally to mobile vehicle client 210. Navigation services may be selected by mobile vehicle client 210, as seen at block 345.

FIG. 4 shows a flow diagram of one embodiment of a method for enhanced navigation services in accordance with the present invention at 400.

Enhanced navigation services method 400 may include a series of steps to provide, for example, navigation-enhanced directory assistance information and navigation information to mobile vehicle client 210. A direct navigation service request may be made, for example, when the address of a business, residence or point of interest is known. The desired city and state of the business, residence or point of interest may be recited or transmitted by mobile vehicle client 210 to a server. Additional business, residence or point of interest requests may be made once the target address is successfully entered and processed. This allows identification of businesses, residences and points of interest in proximity to the target address. For example, a hotel in another city may be used as the target address, and a point of interest request made for restaurants within proximity to the hotel.

As seen at block 405, mobile vehicle client 210 may submit a point of interest request for navigation services. Mobile vehicle client 210 may submit a navigation services request, for example, when the user needs navigation assistance to travel to a desired point of interest.

As seen at block 407, a city/state filter may be used for determining navigation services or directory assistance services for a desired business, residence or point of interest. A particular city or state may be, for example, specified by a subscriber. A particular address specified by the subscriber may, for example, include city and state information. The city/state filter may include a set of constraints used when searching a database for navigation or directory assistance services.

As seen at block 410, an address may be generated from the filtered information. An address may be, for example, a street address, geographical location, or URL. An address of the point of interest may be used as the address entry for subsequent actions. In cases where mobile client 210 knows the address of the desired point of interest, the point of interest address may be used as the address entry. The business, residence or point of interest address may be recited by mobile vehicle client 210 with verbal communications. The business, residence or point of interest address may be transmitted by mobile vehicle client 210 with data communications. The address may be communicated with the request for directory assistance or navigation services.

As seen at block 415, a distance filter may be used to determine suitable points of interest. The distance filter may be optional. The distance filter uses proximity information to define a proximity region around mobile vehicle client 210. The proximity region may be represented by a polygon around the mobile vehicle location. Mobile vehicle client 210 may provide proximity information, or the proximity information may be, for example, default proximity information. The proximity region may be represented, for example, by a polygon containing multiple facets to approximately form a circle around the current mobile vehicle location. The proximity region may be represented, for example, by a polygon in the shape of a square centered on the current mobile vehicle location. The proximity region may be represented, for example, by a polygon in the shape of a corridor on either side of an intended vehicle path. The proximity region may be represented, for example, by a cone-shaped polygon extending around the current mobile vehicle location with the cone pointed in the current direction of travel of the mobile vehicle. The proximity region may be based on the current location and direction of the mobile vehicle, or upon the intended vehicle route. One or more points of interest may be selected from a database based on whether the points of interest lie within the polygon. If no points of interest lie within the polygon, the polygon may be enlarged. If a large number of points of interest lie within the polygon, the polygon may be made smaller or another filter may be used. If the results of the distance filter are unsatisfactory, further filters may be applied. Filters may be, for example, category filters or sub-category filters.

As seen at blocks 420, 425, 430, 435, 440, one of several actions may be taken in response to the filters and address entry. Mobile vehicle client 210 may have a good, general knowledge of the area where the business, residence or point of interest is located, and may require only a street address. In other instances, mobile vehicle client 210 may have no knowledge of the area where the business, residence or point of interest is located, and may require full turn-by-turn routing instructions leading to the destination. The action to be taken may be selected by mobile vehicle client 210. The action taken may also be predetermined. For example, a predetermined response may be a default response. A predetermined response may also be based on a user profile. A predetermined response may also be based on the address entry. The action may provide a series of routing instructions to mobile vehicle client 210. The routing instructions may be provided in a predetermined sequence.

A point of interest download action may be taken, as seen at block 420. The point of interest download may transmit, for example, address entry information regarding the selected point of interest to an autonomous navigation system located on the mobile vehicle. The point of interest download may transmit, for example address entry information and related point of interest information. Related point of interest information may include, for example, type of business or attraction, hours of operation, descriptions about the business or attraction, or any sales or news information.

An address locator action may be taken, as seen at block 425. An address locator action, for example, may provide major exit routing instructions to mobile vehicle client 210. Major exit routing instructions may provide, for example, the freeway exit to be taken by the mobile vehicle. An address locator action, for example, may provide major cross street routing information to mobile vehicle client 210. Major cross street routing instructions may provide, for example, one or more major cross streets to the mobile vehicle en route to a selected business, residence or point of interest. A major cross street may be the conjunction of two arterial roadways. A major cross street may be a less-traveled local street, for example, when cross streets are rare. An address locator action, for example, may provide major intersection routing instructions to mobile vehicle client 210. Major intersection routing instructions may provide, for example, one or more major intersections to the mobile vehicle en route to a selected business, residence or point of interest. A major intersection may be the conjunction of two major roadways. A major intersection may be the intersection of less-traveled local streets, for example, when major intersections are rare. Major exit routing instructions, major cross street routing instructions, and major intersection routing instructions may reference a business, residence or point of interest relative to cross streets or freeway exits. A relative location instruction may be, for example, “destination is two miles south of I-75 Exit 14 on Stephenson Highway”. Relative business, residence or point of interest location instructions may be recited or transmitted to mobile vehicle client 210 from navigation service manager 240. Relative location instructions may be statements of relative position. Relative location instructions may be retained by mobile vehicle client 210 by using, for example, a client vehicle voice recorder.

An address locator action, for example, may provide last-mile routing instructions to mobile vehicle client 210. Last-turn routing instructions may include, for example, one or more routing instructions to mobile vehicle client 210 based on completion of the last instruction. Routing instructions may be provided to mobile vehicle client 210 based on the location of the mobile vehicle with respect to a maneuver. For example, a new routing instruction may be delivered to mobile vehicle client 210 upon successful completion of a turn at a major intersection. Address locator action may occur, for example, when address entry information is delivered to the address locator.

A last-mile navigator action may be taken, as seen at block 430. A last-mile navigator action may provide to mobile vehicle client 210, for example, last-mile routing instructions. Last-mile routing instructions may include, for example, explicit turn-by-turn instructions to the destination point from the nearest freeway exit, major cross street, or major intersection. Last-mile navigator action may occur, for example, when address entry information is delivered to the address locator.

A virtual navigator action may be taken, as seen at block 435. A virtual navigator action may provide to mobile vehicle client 210, for example, voice routing instructions to the destination. Voice routing instructions for the entire route from the mobile vehicle location to the destination, for example, may be provided to mobile vehicle client 210. Voice routing instructions may be provided to mobile vehicle client 210, for example, one instruction at a time. Voice routing instructions may be provided to mobile vehicle client 210, for example, a few instructions at a time. Voice routing instructions may be provided to mobile vehicle client 210, for example, based on completion of a prior instruction. Virtual navigator action may occur, for example, when address entry information is delivered to the address locator.

Voice instructions may be stored, for example, in a voice memo recorder. The voice memo recorder may be located, for example, in the mobile vehicle. Voice memo routing instructions for the entire route, for example, may be provided to mobile vehicle client 210. Voice memo routing instructions may be provided to mobile vehicle client 210, for example, one instruction at a time. Voice memo routing instructions may be provided to mobile vehicle client 210, for example, a few instructions at a time. Voice memo routing instructions may be provided to mobile vehicle client 210, for example, based on completion of a prior instruction.

A turn-by-turn route guidance action may be taken, as seen at block 440. A turn-by-turn route guidance action may provide to mobile vehicle client 210, for example, turn-by-turn routing instructions. Turn-by-turn routing instructions may include, for example, complete turn-by-turn routing information from the current position of the mobile vehicle to the destination. Turn-by-turn route guidance action may occur, for example, when address entry information is delivered to the address locator.

Routing instructions may be provided to mobile vehicle client 210 using a voice user interface. Delivery of routing instructions to the mobile vehicle may be provided according to a routing option input from mobile vehicle client 210. The routing option input may be a mobile vehicle user selection. The routing option input may be a predetermined selection such as a default selection, or based on a user profile. The routing option input may also be based on the navigation services requested. Routing instructions may also be provided to mobile vehicle client 210 using a graphical user interface. A graphical user interface may be, for example, a heads-up display.

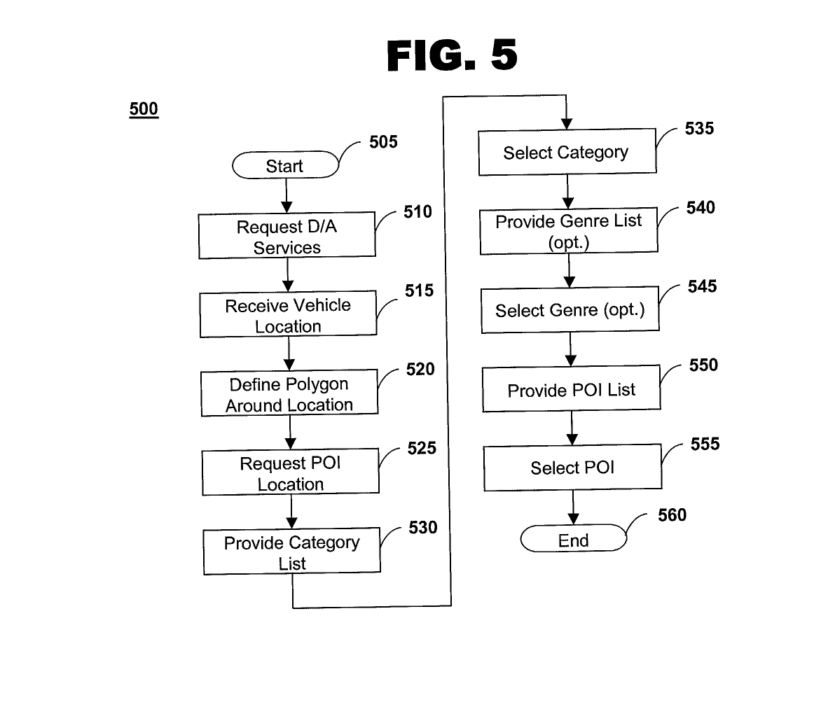

FIG. 5 shows a flow diagram of another embodiment of a method for enhanced directory assistance in accordance with the present invention at 500. Enhanced directory assistance method 500 may include a series of steps to provide, for example, navigation-enhanced directory assistance.

Enhanced directory assistance method 500 starts as seen at block 505. A navigation-enhanced directory assistance user may make a point of interest request for enhanced directory assistance services as seen at block 510. A navigation-enhanced directory assistance user may be, for example, mobile vehicle client 210. A navigation-enhanced directory assistance user may be, for example, a subscriber. A subscriber may request navigation-enhanced directory assistance at, for example, a call center. A call center may be, for example, a land-based site equipped with suitable hardware and software to provide the requested services. A subscriber may contact a call center to request navigation-enhanced directory assistance services.

As seen at block 515, a call center may receive a current vehicle location of a subscriber. A polygon may be defined around the current vehicle location as seen at block 520. The polygon may be defined by a radius around the current vehicle location. The radius may be determined by the subscriber. The radius may be determined based, for example, by a subscriber profile or by road density. The subscriber may articulate a location request for a business, residence, or point of interest as seen at block 525. The call center may present a list of business or POI categories, such as restaurants, hardware stores, or golf courses as seen at block 530. The subscriber may select a category, as seen at block 535. Restaurants may be an example of a category. The call center may accept the category and may respond with a sub-category list as seen at block 540. A sub-category list may provide detailed genres for the selected category. As seen at block 545, the subscriber may select from the sub-category list. An example of a sub-category list for a restaurant category may be restaurant specialties such as French, Italian or Thai dishes. The call center may accept the sub-category and may present a list of specific businesses or points of interest as seen at block 550. As seen at block 555, the subscriber may select a business or point of interest from the presented list. The request for navigation-enhanced directory services may end, as seen at block 560. The subscriber may further request navigation services for the selected business or point of interest.

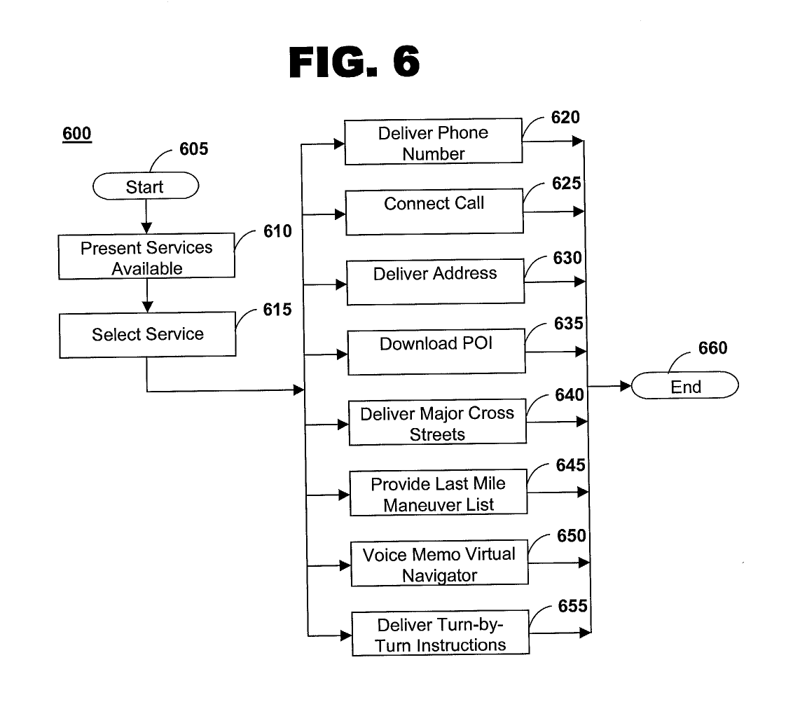

FIG. 6 shows a flow diagram of another embodiment of a method for enhanced navigation services in accordance with the present invention at 600. Enhanced navigation services method 600 may include a series of steps to provide, for example, navigation-enhanced directory assistance.

Enhanced navigation services method 600 may start as seen at block 605. A navigation-enhanced directory assistance user or subscriber may make a point of interest request for enhanced navigation services. Enhanced navigation services may be requested by contacting a call center. The call center may present the subscriber with a list of directory assistance and navigation-enhanced directory assistance services as seen at block 610. As seen at bock 615, the subscriber may select a desired directory assistance service or navigation-enhanced directory assistance service. Examples of directory assistance services or navigation-enhanced directory assistance services include: deliver phone number; connect call; deliver address; download point of interest; deliver major cross streets; provide last-mile maneuver list; deliver instructions for voice memo virtual navigator; and deliver turn-by-turn instructions, as seen at blocks 620, 625, 630, 635, 640, 645, 650 and 655, respectively. Routing instructions may be provided to mobile vehicle client 210 in response to a routing option input supplied by the subscriber.

The subscriber may request that a phone number of the selected business or point of interest be delivered to the subscriber, as seen at block 620. The subscriber may request that a call be connected as seen at block 625. The subscriber may then be connected to the selected business or point of interest. As seen at block 630, the subscriber may request that the address of the business or point of interest be delivered to the subscriber. As seen at block 635, the subscriber may request that information regarding the business or point of interest be downloaded. The business or point of interest information may be downloaded to the vehicle if, for example, an autonomous navigation system is present.

As seen at block 640, the subscriber may request an address locator be delivered to the subscriber. The address, freeway exit, and major cross street may be delivered to the subscriber. Navigational instructions may encompass relative address information. Navigation instructions may provide incremental specificity to the subscriber. Navigation instructions may be referenced, for example, to a freeway exit or major cross street. Navigation instructions may be delivered to mobile vehicle client 210, for example, one instruction at a time as the mobile vehicle traverses an intended route. The mobile vehicle location may be periodically transmitted to navigation service manager 240 where a server may match the location of the mobile vehicle to the intended route. After the position is matched to the intended route and the mobile vehicle is in the vicinity of the next pending maneuver, the maneuver may be recited or transmitted to mobile vehicle client 210 for presentation to the subscriber. If the mobile vehicle strays from the intended route, an off-route message may be recited or transmitted to mobile vehicle client 210. An off-route message may be an alarm delivered to mobile vehicle client 210. An off-route message may include further routing instructions to allow the mobile vehicle to return to the intended route. If the vehicle returns to the intended route, then position matching to the intended route may resume.

As seen at block 645, the subscriber may request a last-mile maneuver list. The last-mile maneuver list may contain explicit, turn-by-turn instructions from the nearest freeway exit or major intersection to the selected destination. As seen at block 650, the subscriber may request the services of a virtual navigator. Voice instructions may be delivered to the subscriber. The voice instructions may be optionally captured in a voice memo recorder. As seen at block 655, the subscriber may request delivery of turn-by-turn instructions. Complete turn-by-turn routing instructions from the current position of the subscriber to the destination of the subscriber are delivered to the subscriber. The request for enhanced navigation services may end, as seen at block 660.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of providing navigation instructions to a mobile vehicle, comprising:
selecting a point of interest from within a proximity region of a mobile vehicle location based on a point of interest request;
determining a plurality of routing instructions based on the selected point of interest; and
providing at least one of the routing instructions to the mobile vehicle in response to a routing option input.

2. The method of claim 1 wherein the routing option input comprises a mobile vehicle user selection.

3. The method of claim 1 wherein the routing option input comprises a predetermined selection.

4. The method of claim 1 wherein the point of interest request is based on at least one item selected from a group consisting of distance between the point of interest and the mobile vehicle, category of the point of interest, and sub-category of the point of interest.

5. The method of claim 1 wherein the point of interest selection includes at least one voice communication.

6. The method of claim 1 wherein the proximity region is comprised of a polygon containing the mobile vehicle location.

7. The method of claim 1 wherein a plurality of the routing instructions are provided to the mobile vehicle in a predetermined sequence.

8. The method of claim 7 further comprising:
providing the routing instructions to a mobile vehicle user.

9. The method of claim 8 wherein the routing instructions provided to the mobile vehicle user are selected from a group consisting of major exit routing instructions, major cross street routing instructions, major intersection routing instructions, last-mile routing instructions, turn-by-turn routing instructions, last-turn routing instructions, voice routing instructions, and voice memo routing instructions.

10. The method of claim 8 wherein the routing instructions are provided to the mobile vehicle user via a graphical user interface.

11. The method of claim 8 wherein the routing instructions are provided to the mobile vehicle user via a voice user interface.

12. The method of claim 8 wherein the routing instructions are provided to the mobile vehicle user based on location of the mobile vehicle with respect to a maneuver.

13. The method of claim 1 further comprising:
providing the selected point of interest to an autonomous navigation system.

14. The method of claim 1 further comprising:
transmitting the routing instructions to the mobile vehicle using at least one wireless link.

15. A computer usable medium including a program for providing navigation instructions to a mobile vehicle, comprising:
computer program code for selecting a point of interest from within a proximity region of a mobile vehicle location based on a point of interest request;
computer program code for determining a plurality of routing instructions based on the selected point of interest; and
computer program code for providing at least one of the routing instructions to the mobile vehicle in response to a routing option input.

16. The computer usable medium of claim 15 further comprising:
computer program code for providing the routing instructions to a mobile vehicle user.

17. The computer usable medium of claim 15 further comprising:
computer program code for providing the selected point of interest to an autonomous navigation system.

18. The computer usable medium of claim 15 further comprising:
computer program code for transmitting the routing instructions to the mobile vehicle using at least one wireless link.

19. A directory assistance system for providing navigation instructions to a mobile vehicle comprising:
means for selecting a point of interest from within a proximity region of the mobile vehicle location based on a point of interest request;
means for determining a plurality of routing instructions based on the selected point of interest; and
means for providing at least one of the routing instructions to the mobile vehicle in response to a routing option input.

20. The system of claim 19 further comprising:
means for transmitting the routing instructions to the mobile vehicle including at least one wireless link.
